(19) United States
(12) Patent Application Publication
(10) Pub. No.: US 2002/0138189 A1
(43) Pub. Date: Sep. 26, 2002

(54) Method and apparatus for determining brake balance through the use of a temperature sensing element in a wheel speed sensor

(76) Inventor: James M. Kubik, Avon Lake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/814,579

(22) Filed: Mar. 22, 2001

(51) Int. Cl. G06F 17/00

(52) U.S. Cl. 701/71; 701/70; 701/78; 188/276

(57) ABSTRACT

A method for monitoring the distribution of braking force over a plurality of wheels during a braking event is disclosed. The method employs a multi-function sensor (62) which includes both wheel speed sensing capability in association with a tone ring (64), and temperature sensing capability in the form of a temperature sensor (180). The temperature sensor is preferably a thermocouple sensor such as an iron-constantan thermocouple sensor. The temperature of the brake environment during a braking event is roughly proportional to the work expended by the brake in decelerating the wheel, and so the braking force distribution over the plurality of wheels may be characterized by the variation in the reported temperatures during the braking event.

### BACKGROUND OF THE INVENTION

The present invention relates to vehicle sensor technology, and more specifically to sensor technology for monitoring braking systems, especially anti-lock braking systems (ABS). However, it will be appreciated that the invention may additionally find application in other vehicle sensing and control systems such as those for torque application control, safety sensors, and the like, and its description in conjunction with an anti-lock braking system should not be construed as limiting the invention thereto.

It is important that all axles on a vehicle apply and release their brakes uniformly and that each axle generates a relatively equal level of braking performance. Unbalanced braking performance may result in longer braking distances, an enhanced tendency toward skidding, and the like. For various reasons including the mixture of braking types now on the market, the various combinations of these braking types on a given highway vehicle, design variations among braking types, improper installation, and lack of maintenance, a given vehicle may have non-optimum braking balance among the various axles.

Non-optimum braking balance is typically not readily apparent to an inexperienced operator in real time. Consider for example an extreme case where front brakes are inoperative and rear brakes are fully operative. During braking in the absence of skidding, the rotation of each axle will decelerate at exactly the same rate, even though there is no braking applied to the front wheels in this extreme example. Thus, wheel rotation speed sensors will not detect the inoperative front braking, although of course other electronic sensors may detect such an extreme malfunction. The vehicle operator would recognize this situation only as a reduced overall braking capability resulting in a longer braking distance. But this recognition will only occur if the operator is already familiar with the optimum braking performance of the vehicle. Of course, less extreme unbalanced braking would be correspondingly difficult to detect by the vehicle operator, and these less extreme braking imbalances may go undetected for long time periods even by experienced vehicle operators.

### SUMMARY OF THE INVENTION

In accordance with one aspect of the present invention, a method for monitoring braking force distribution among a plurality of brakes is disclosed. The method includes the steps of measuring a temperature of each brake environment and determining a distribution of energy dissipation among a plurality of wheels during a braking event in response to the measuring step.

In accordance with another aspect of the present invention, a multi-function sensor for measuring the performance of a brake includes an element for measuring rotational speed of an associated wheel and a temperature sensing element operatively associated with the element which measures the temperature of an associated brake environment.

In accordance with yet another aspect of the present invention, a brake monitoring system for a multiple-wheeled vehicle includes a plurality of multi-functional sensors, each sensor associated with a wheel and associated brake environment. Each sensor measures rotational speed of the wheel and temperature of a brake environment. An electronic control unit (ECU) receives the speed and temperature data supplied by the plurality of multi-functional sensors.

One advantage of the present invention relates to the ability to monitor the distribution of braking across the axles of a multiple-axle vehicle.

Another advantage of the present invention resides in detecting and reporting brake degradation of one or more axles, thereby potentially detecting a brake malfunction at an early stage.

Another advantage of the present invention relates to monitoring of the braking distribution of vehicles in a fleet, thereby facilitating tracking of maintenance effectiveness and the reliability of various brake types.

Yet another advantage of the present invention is realized by additional temperature monitoring capabilities without requiring an additional sensor.

Still further advantages and benefits of the present invention will become apparent to those of ordinary skill in the art upon reading and understanding the following detailed description.

### BRIEF DESCRIPTION OF THE DRAWINGS

The invention may take form in various components and arrangements of components. The drawings are only for the purposes of illustrating preferred embodiments and are not to be construed as limiting the invention.

FIG. 1 is an exploded view of a brake environment which includes the multi-functional sensor.

FIG. 2 is a sectional view of the multi-functional sensor.

### DETAILED DESCRIPTION OF THE PREFERRED EMBODIMENT

The present invention discloses a new vehicle sensing system which incorporates an apparatus and method for characterizing the braking distribution among the axles. The system measures a temperature of a brake environment associated with each brake. The brake environment, as used throughout this description, refers to a wheel hub assembly, associated tone ring, brake drum or other brake mechanism, and any additional components which are part of or in close proximity to the brake and largely isolated from an outside environment. The brake environment experiences a significant temperature rise during a braking event, and this temperature rise is relatively uniform throughout the brake environment. Therefore, tracking the temperature of the brake environment during a braking event provides an easily quantified relative figure of merit of the amount of energy dissipated during the braking event which, in turn, relates to the work done by the brake.

Recognizing the relatively confined space within the brake environment, the invention in a preferred embodiment advantageously integrates a temperature sensor into a wheel speed sensor which is already included in the brake environment of vehicles having anti-lock braking systems.

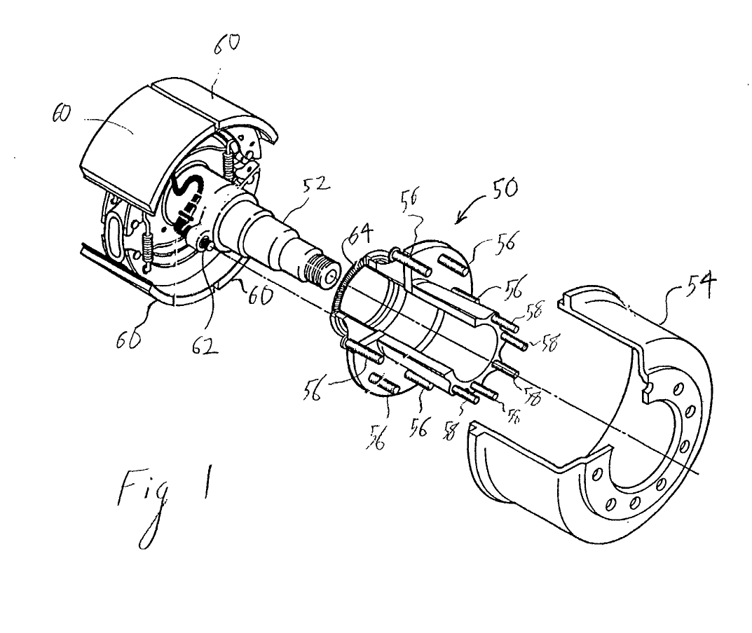

The invention will be illustrated within a brake environment with reference to FIG. 1, which shows an exploded view of principal components comprising a drum brake environment with a multi-functional sensor incorporated therein. Although the invention is described with respect to a drum brake system, it is to be appreciated that the invention will function equally well in conjunction with other brake types such as disk brakes, and within other brake environments.

As shown in FIG. 1, a wheel hub assembly 50 is attached to an axle end 52. A brake drum 54 is rigidly and non-rotatably secured to wheel hub assembly 50 using fasteners 56, which are typically bolts or the like. Wheel hub assembly 50 additionally has bolts 58 for securing a wheel in a well-known manner (not illustrated). Brake shoes 60 are disposed within brake drum 54, and move radially outward, for example, to engage brake drum 54 during a braking event. Frictional braking force between the stationary brake shoes 60 and rotating brake drum 54 dissipates the energy and results in rotational deceleration of the brake drum 54 and associated wheel hub assembly 50 and axle end 52.

In an anti-lock braking system, the braking force applied to each wheel is independently adjusted during a braking event to reduce the possibility of skidding, hydroplaning, or the like. To implement anti-lock braking, a wheel speed sensor is required for each wheel, which in the present invention is implemented as a multi-function sensor 62 which includes speed sensing capability. Sensor 62 is rigidly mounted to axle end 52 and together with associated tone ring 64 is used to measure the wheel speed. Tone ring 64 is integrally connected to either the brake drum 54 or the wheel hub assembly 50 and rotates therewith. In the preferred, illustrated embodiment, the tone ring 64 is pressed into wheel hub assembly 50.

Tone ring 64 has a circumferentially varying periodic magnetic reluctance along an outer edge, produced for example by having a toothed edge. As the tone ring rotates, a temporally periodic reluctance is presented to the stationary sensor 62. The frequency of this temporal reluctance variation is directly proportional to the wheel speed, thus permitting measurement thereof.

It will also be observed in FIG. 1 that stationary multi-function sensor 62 lies almost directly between the brake shoes 60, so that sensor 62 lies reasonably well-centered within the brake environment. It is therefore ideally positioned for its second function, namely measuring the brake environment temperature during a braking event. Since the brake environment is substantially closed, the sensor can be located at other positions therein without departing from the scope and intent of the present invention.

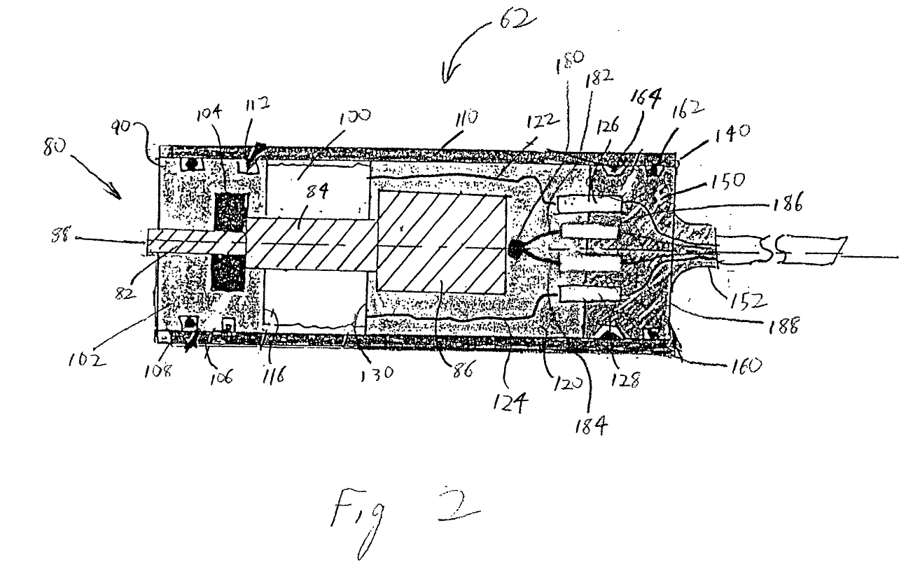

The multi-function sensor 62 will now be described in greater detail with reference to FIG. 2. Particularly, sensor 62 includes a one-piece pole and magnetic flux concentrator 80 formed from metal and having three distinct regions or portions 82, 84, 86. The first portion 82 has the smallest diameter, for example, on the of order 0.10 inches in diameter. This portion defines a pole of the one-piece pole/concentrator. As such, the first region includes an end 88 that extends outwardly from a first end 90 of the sensor assembly. As one skilled in the art will appreciate, it is important that the dimension between the pole and the tone ring (64 in FIG. 1) be maintained at a minimum. For example, a gap on the order of 0.010 inches is desirable to obtain maximum sensor performance. It is also preferable that the pole be exposed at the end of the sensor assembly, i.e., not encased or shrouded, so that sensitivity or gap tolerance of the sensor is not compromised.

The second region 84 of the pole/concentrator is of an intermediate diameter. As will become more apparent below, the second region serves as an internal support for winding 100. For example, a large number of turns are used in the winding to amplify the signal. In a preferred arrangement, the winding is approximately 450 feet long by using numerous turns of 0.002 inch wire. It will be appreciated, however, that a different diameter wire, or greater or lesser number of turns, or length of wire can be used to achieve the desired results.

The third region 86 of the pole/concentrator preferably has the largest cross-sectional dimension. The third region serves as a large metal mass to concentrate the signal picked up or detected at the pole end and ultimately conveyed to an electronic control unit (not shown) of an anti-lock brake system or traction control system.

A first material or plastic overmold is formed over a substantial portion of the first region of the pole/concentrator, and partially over the second region 14. The mold material 102 also locates and confines in place a magnet 104. The magnet is preferably an annular configuration dimensioned for receipt over the first region 82 and abutting against the stepped interface between the first and second regions 82, 84 of the pole/concentrator. This arrangement advantageously locates the magnet close to the pole end which also improves the performance of the sensor.

The first material 102 forms an end cap and preferably includes an external groove 106 that receives a seal member, such as O-ring seal 108, therein. The O-ring is circumferentially continuous and provides a suitable barrier to the internal components of the sensor assembly from the external environment. An outer diameter of the first material is preselected to conform to an inner diameter of a stainless steel, seamless tubing or sleeve 110. Thus, the O-ring provides a seal interface between the first material and the sleeve 110 at a first end of the sensor assembly. When axially inserted into the sleeve 110, the end 90 of the first material is aligned with the end of the sleeve 110, and then a mechanical connection, such as circumferentially spaced crimps 112, is provided in the sleeve to mechanically interlock the individual components of the wheel speed sensor together.

A second end 116 of the first material defines a radial wall or abutment for the winding 100. Similarly, a second material 120 is received over the third region 86 of the pole/concentrator. This is preferably a plastic overmolded material that has an outer diameter substantially identical to the inner diameter of the sleeve 110. Opposite ends of the winding include leads 122, 124 that extend through the second material for connection with conductor pins 126, 128, respectively at one end of the second material. The connector pins may be integrally molded in the second material or recesses provided therein to receive the connector pins. Thus, a first end 130 of the second material forms an abutment for the winding 100. It cooperates with the end face 116 of the first material, the inner diameter of the sleeve, and the outer diameter of the second region 84, to define a cavity that serves as a bobbin for the winding.

It will be further appreciated that the axial length of the sleeve 110 and that of the second material are selected so that the conductor pins 126, 128 are disposed inwardly from a second end 140 of the sensor assembly. A third material or end cap 150 is axially dimensioned to fill the remainder of the cavity defined by the sleeve. It is preferably a plastic overmolded component that receives the conductor pins along an interior face and includes a neck or reduced dimension region 152 that extends outwardly from the end of the assembly to serve as a wiring harness leading to the electronic control unit. In the embodiment of FIG. 2, the configuration of the extension is a straight extension; however, a 90° or right-angled shoulder, or other configuration is also contemplated, and may be preferable depending upon the available space within the braking assembly.

The third material also includes an external groove 160 that receives a seal member, such as O-ring seal 162, therein. The seal member provides a sealed interface between the inner diameter of the sleeve and the outer diameter of the third material adjacent the second end 140 of the sensor assembly. In addition, the third material is axially locked or mechanically connected to the sleeve via a series of circumferentially spaced crimps 164, whereby the tubing is radially deformed to grip the third material. This provides a simplified mechanical connection that does not breach the integrity of the seamless tubing used to form the sleeve. Consequently, the internal components of the sensor assembly are adequately sealed from the external environment.

The above-described components cooperate together and with associated tone ring 64 to provide the wheel speed sensing function of multi-function sensor 62. Temperature sensing capability is provided by temperature sensor 180 in cooperation with leads 182, 184 connected to conductor pins 186, 188. Temperature sensor 180 is preferably a thermocouple sensor such as an iron-constantan thermocouple sensor. Temperature sensor 180 is preferably located along a cylindrical axis-of-symmetry of sensor 60 so that sensitivity to mounting variations are minimized, and additionally is preferably in contact with third region 86 to provide a continuous metallic thermal conduction path through second region 84 and first region 82 to the brake environment. However, other temperature sensor locations are also contemplated, such as placing temperature sensor 180 in contact with metallic sleeve 110, thereby providing a more direct thermal conduction path to the brake environment. Similar to connector pins 126, 128, connector pins 186, 188 may be integrally molded in the second material or recesses provided therein to receive the connector pins.

Assembly of the components preferably proceeds as follows. The one-piece pole/magnetic flux concentrator receives magnet 104 over the first region 82. Preferably, the magnet abuts against the stepped interface with the second region 84. The first end cap 102 is then integrally molded over the first region of the pole/concentrator and a portion of the second region, as well as the permanent magnet. A second material 120 is molded over the concentrator region 86, the temperature sensor 180, and over part of the end of second region 84. The winding 100 is wound in the cavity to the desired number of turns and the leads 122, 124 provided through the second material and welded to connector pins 126, 128. Similarly, leads 182, 184 of temperature sensor 180 are secured (e.g., welded) to connector pins 186, 188. O-ring 108 is then positioned in place in its associated groove 106 and this subassembly, or cartridge, inserted into the sleeve 110. The second end cap is inserted in the end of the sleeve, the O-ring 162 is positioned in the respective groove 160, the connector pins attached in place, and the entire assembly crimped as represented by reference numerals 112, 164.

This simplified socket and tube assembly provides a multi-function sensor that carefully controls the distance between the pole and the tone ring to facilitate wheel speed measurements while additionally providing temperature measurement capability in a unit no larger than a conventional commercial speed sensor.

During a braking event there is an energy transfer into the brake pads and the brake drum or disc. Some of this energy is transformed into work as the frictional force opposes the wheel rotation and produces the desired deceleration. However, a large component of the energy is transformed into heat, resulting in an increase in the temperature of the brake environment which is roughly proportional to the amount of decelerating work. Thus, the temperature measured by sensor 62 relates to the amount of braking force applied, and so the distribution of the total braking force across the various wheels can be monitored.

The temperature monitoring function of multi-function sensor 62 is preferably controlled by a modified electronic control unit (ECU) presently envisioned as being essentially similar to the ECU presently employed for anti-lock braking control. However, additional inputs and control circuitry for the temperature sensors are contemplated. Temperature data may be forwarded to a dashboard display, such as a complete graphical display which tracks the temperature of each axle; or to a simple dashboard warning lamp which warns the operator by lighting when the braking force is unbalanced with respect to one or more wheels beyond a specified tolerance. The warning display may alternately indicate which wheel is behaving abnormally. It is also envisioned that temperature data may be stored in an on-vehicle memory for subsequent display and later transferred to an external system via a port (not shown) for analysis, as might be desired by a truck fleet manager or a maintenance technician.

The data gathered by the multi-functional sensors can be used in a variety of manners. For example, a real-time temperature can be recorded. Alternately, a preselected temperature range or tolerance can be established so that information is only recorded if the temperature falls outside the preselected range. If the temperature of particular brake environment stays within a desired range, then no value may be recorded. It is also envisioned that the multi-function sensor is best adapted to provide data for ABS use and brake environment temperature for use in monitoring brake balance. It is even contemplated that the temperature data representation of brake balance can be used to adjust the braking force via the ECU or inform a vehicle operator or maintenance personnel that brake adjustment is required. The invention, though, should not be limited to the particular multi-function sensor shown and described herein, nor limited to the particular method employed in the preferred embodiment.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method for monitoring braking force distribution among a plurality of brakes, the method comprising the steps of:
measuring a temperature of brake environments; and
determining a distribution of energy dissipation among the brake environments during a braking event in response to the measuring step.

2. The method for measuring braking force distribution of claim 1 further comprising the step of tracking the temperature of brake environments as a function of time during the braking process.

3. The method for measuring braking force distribution of claim 2 further comprising the step of reporting a first value indicating all brake environments tracked temperature uniformly to within a preselected tolerance.

4. The method for measuring braking force distribution of claim 3, further comprising the step of reporting a second value indicating that the temperature of at least one brake environment tracked outside of the preselected tolerance.

5. The method for measuring braking force distribution of claim 4, where for the first value a status report displays no information.

6. The method for measuring braking force distribution of claim 4, where for the second value a status report identifies the brake environment which is outside the preselected tolerance.

7. The method for measuring braking force distribution of claim 2 further comprising the step of reporting to an associated vehicle operator a real-time temperature of each brake environment.

8. A multi-function sensor for measuring the performance of a brake, the sensor comprising:
an element for measuring the rotational speed of an associated wheel; and
a temperature sensing element, operatively associated with the element, which measures the temperature of an associated brake environment.

9. The multi-function sensor of claim 8, wherein the temperature sensing element is a thermocouple.

10. The multi-function sensor of claim 9, wherein the element for measuring rotational speed and the thermocouple are contained in a single unit.

11. The multi-function sensor of claim 8, wherein the element for measuring rotational speed is an electromagnetic sensor including:
a magnet;
a pole associated with the magnet; and
a winding encompassing the pole.

12. The multi-function sensor of claim 11, wherein the temperature sensing element is a thermocouple.

13. The multi-function sensor of claim 12, wherein the element for measuring rotational speed and the thermocouple are contained in a single unit.

14. A brake monitoring system for a multiple wheeled vehicle, comprising:
a plurality of multi-functional sensors, each sensor associated with a wheel and associated brake environment, each sensor measuring rotational speed of the wheel and temperature of a brake environment; and
an electronic control unit (ECU) which receives the speed and temperature data supplied by the plurality of multi-functional sensors.

15. The brake monitoring system of claim 14, wherein the ECU adjusts the braking force applied to each axle based on the received speed data.

16. The brake monitoring system of claim 14, wherein the ECU adjusts the braking force applied to each axle based on the received speed and temperature data.

17. The brake monitoring system of claim 14, wherein the system includes anti-lock braking capability.

18. The brake monitoring system of claim 17 further comprising a display for providing an associated vehicle operator with information regarding the brake system.

19. The brake monitoring system of claim 18, wherein the display shows real-time temperature of each brake environment.

20. The brake monitoring system of claim 18, wherein the display warns an associated vehicle operator when unbalanced braking is detected.

21. The brake monitoring system of claim 17, further comprising:
a memory unit which stores temperature data acquired by the sensors; and
a port by which the stored temperature data may be transferred from the vehicle to an associated independent storage memory.
